(19) United States
(12) Patent Application Publication
(10) Pub. No.: US 2009/0070428 A1
(43) Pub. Date: Mar. 12, 2009

(54) Method and device for sending e-mail according to postal address

(76) Inventors: Moran Olavri, Hadera (IL); Oren Golbery, Hadera (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/899,472

(22) Filed: Sep. 7, 2007

(51) Int. Cl. G06F 15/82

(52) U.S. Cl. 709/206

(57) ABSTRACT

Directory and storage of addresses in electronic form arranged according to the physical postal address. Directory including sub-directory according multiple email addresses at the same physical address. Computer program to support search for addresses. Computer program to store electronic mail giving access to the recipient. Security provision to allow access only to authorized persons.

### FIELD OF THE INVENTION

This invention is in the field of electronic mail and in particular access to electronic mail stored according to the regular postal mail address. A web site houses the connected programs, the translation program and the operating program.

### BACKGROUND OF THE INVENTION

The use of email for written communication has become widespread due to the many advantages of this electronic communication over the older method of writing on paper and posting in the postal system. Among the advantages are negligible running cost, speed of delivery to the destination, twenty-four hour service, ability to attach most types of digital files including text, photographs, videos, music and organized filing system both of letters sent and those received with their respective attachments. However, people are often best remembered and identified by their physical postal address and people do not change their postal addresses as often as they change their electronic addresses. Electronic addresses are easily changed at short notice and competitive offers by competing companies often tempt people to change their electronic address requiring communication to all those registered in the electronic address book to be informed and alter their records. This can cause confusion and error as people do not always adjust their address books promptly and accurately.

This invention comes to solve these problems by making an electronic directory based on the physical postal address of potential addressees. It is designed to accommodate the needs of those who are more familiar with the postal address of addressees and want to use an efficient, secure and fast method of sending mail. The invention also reveals an electronic postal service managed on the internet web site of the operating company.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

An object of this invention is to make an electronic directory arranged according to the details of the physical addresses. Another object of this invention is to transfer physical addresses or post office box numbers to a digital memory for internal mail.

Another object of this invention is to add to the electronic directory a sub-directory arranged according to the details of more than one email address relevant to persons at the same physical address.

Another object of this invention is to store mail sent at the address of the recipient that has been allotted to that recipient.

Another object of this invention is to operate transfer of electronic mail from a digital directory according to the physical home address by state of the art email technology to the said allotted address of the recipient.

Another object of this invention is to operate transfer of electronic mail by direct access after identification to the memory of the operating company.

Another object of this invention is to have a software program to support the various objects of this invention.

Another object of this invention is to include in the said software program a security system to ensure access to the said program by authorized persons only.

Another object of this invention is to run the program of this invention on an internet web site.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a flowchart showing the steps involved in the operation of the computer program of this invention when sending mail and checking incoming mail.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

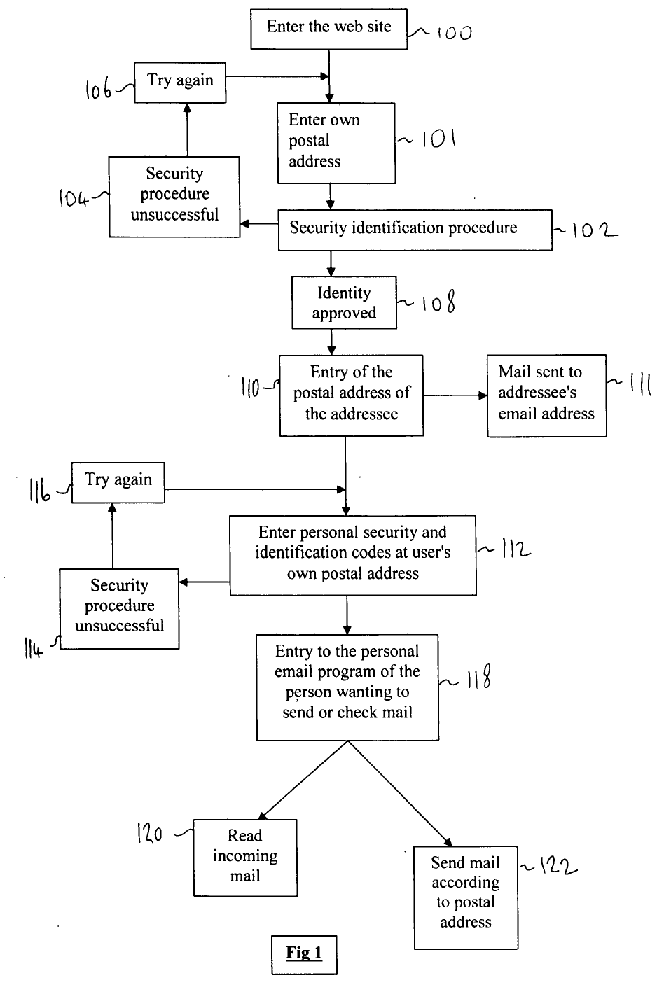

FIG. 1 shows the first stage is to enter the web site 100 of this invention and enter the user's own postal address 101. The user has to pass a security identification test procedure 102 to ensure only authorized users use the program. The identification procedure 102 could include entering the user's home postal address comprising the country, city, street, house number and/or any post office box number and in addition, a personal password. If the test fails 104 for whatever reason, there could be an option to try again 106. May be some detail was entered incorrectly and the next time the identity will be approved 108.

The user then chooses the box provided, the postal address 110 of the relevant home addressee. The addressee's email address will automatically be entered into the box for home addressees in the user's electronic mail program and be ready to be sent 111 when desired.

If there is more than one email address associated with that postal address, the user will be shown a list of names of persons associated with that postal address who have email addresses. The user will choose the name of the person he wishes to communicate with and that addressee's email address will automatically be entered into the box for addressees in the user's electronic mail program. In this case too the mail will be ready to send 111 when desired.

If the user wishes to check incoming mail, he can enter his own postal address and a further security code 112 to reach his personal electronic post box. This further security code 112 would be different from the first security code 102.

Similarly, provision would be made for unsuccessful attempts 114 to have the opportunity to try again 116 for an unlimited or for a limited number of times depending on the level of security desired.

Successful entry to the personal email post box of the user 118 will enable him to check his incoming mail 120 and send mail 122 according to the physical postal address of the addressee.

What is claimed: The present invention is not intended to be limited to the embodiments described above, but to encompass any and all embodiments within the scope of the following claims.

1. A method and device for organizing email addresses according to physical postal addresses comprising,
a. A computer software program to operate, on an internet web site, the various functions of this method and device,
b. A compilation of electronic mail addresses arranged according to the physical postal address of the owner of the electronic mail address.
c. A means to electronically search for home addresses according to recorded detail of the physical postal address,
d. A system of entering an identification code to allow entry of authorized persons only,
e. The ability to read incoming electronic mail, and
f. The ability to send outgoing mail to addresses according to their physical postal address.

2. A method and device as claimed in claim 1 further comprising the pre-requisite use of security codes to enter the said computer program.

3. A method and device as claimed in claim 2 wherein the failure to enter the said computer program prevents further attempts to enter the said computer program.

4. A method and device as claimed in claim 2 wherein further attempts can be made to enter the said computer program after the initial failure to enter the said computer program.

5. A method and device for organizing home addresses according to place in memory of physical postal addresses comprising,
a. A computer software program to operate, on an internet web site, the various functions of this method and device,
b. A compilation of electronic mail addresses arranged according to the physical postal address of the owner of the electronic mail address,
c. A further compilation of electronic mail addresses of dwellers at the same physical postal address,
d. A means to electronically search for email addresses according to recorded detail of the physical postal address,
e. A means to electronically search for email addresses in the said further compilation,
f. A system of entering an identification code to allow entry of authorized persons only,
g. A system of entering a further identification code to allow entry to the said further compilation,
h. The ability to read incoming electronic mail, and
i. The ability to send outgoing mail to addresses according to their physical postal address.

6. A method and device as claimed in claim 5 further comprising the pre-requisite use of security codes to enter the said computer program.

7. A method and device as claimed in claim 5 further comprising the pre-requisite use of security codes to enter the said further compilation.

8. A method and device as claimed in claim 6 wherein the failure to enter the said computer program prevents further attempts to enter the said computer program.

9. A method and device as claimed in claim 6 wherein the failure to enter the said computer program prevents further attempts to enter the said further compilation.

10. A method and device as claimed in claim 6 wherein further attempts can be made to enter the said computer program after the initial failure to enter the said computer program.

11. A method and device as claimed in claim 6 wherein further attempts can be made to enter the said computer program after the initial failure to enter the said further compilation.

12. A method and device for organizing home addresses according to place in memory of physical postal addresses comprising,
a. A computer software program to operate the various functions of this method and device,
b. A compilation of electronic mail addresses arranged according to the physical postal address of the owner of the electronic mail address,
c. A further compilation of electronic mail addresses of dwellers at the same physical postal address,
d. A means to electronically search for email addresses according to recorded detail of the physical postal address,
e. A means to electronically search for email addresses in the said further compilation,
f. A system of entering an identification code to allow entry of authorized persons only,
g. A system of entering a further identification code to allow entry to the said further compilation,
h. The ability to read incoming electronic mail, and
i. The ability to send outgoing mail to addresses according to their physical postal addresses.

13. A method and device as claimed in claim 12 further comprising the pre-requisite use of security codes to enter the said computer program.

14. A method and device as claimed in claim 12 further comprising the pre-requisite use of security codes to enter the said further compilation.

15. A method and device as claimed in claim 13 wherein the failure to enter the said computer program prevents further attempts to enter the said computer program.

16. A method and device as claimed in claim 13 wherein the failure to enter the said computer program prevents further attempts to enter the said further compilation.

17. A method and device as claimed in claim 13 wherein further attempts can be made to enter the said computer program after the initial failure to enter the said computer program.

18. A method and device as claimed in claim 13 wherein further attempts can be made to enter the said computer program after the initial failure to enter the said further compilation
